(19) United States
(12) Patent Application Publication
(10) Pub. No.: US 2007/0057010 A1
(43) Pub. Date: Mar. 15, 2007

(54) Kinetic hammer with self-feeding mechanism

(76) Inventor: Michael J. Byrne, Keystone Heights, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/221,255

(22) Filed: Sep. 7, 2005

(51) Int. Cl. B25B 21/02

(52) U.S. Cl. 227/133; 173/1; 227/136

(57) ABSTRACT

The present invention pertains to a hammer wherein the head can have a spring-loaded sliding weight sufficient for driving fastener objects, such as nails, tacks, brads, or similar objects. Also provided is a coil-spring mechanism utilized with a trigger mechanism that can automatically advance the fastener objects through the handle of the hammer into the head of the hammer one at a time.

### BACKGROUND OF INVENTION

The subject invention relates generally to hammers, in particular, hand-held hammers. It is well known in the art that typical hand-held hammers are designed to pound or drive various types of fastener objects, for example, nails, tacks, brads, etc., into another material or object one at a time. While most hammers can pound or drive such fasteners, the process tends to be relatively slow because the user is required to hold each nail or tack prior to striking with the hammer head. Various pneumatic, electric or other automatic hammers usually require access to air hoses, or electrical cords and power outlets. The subject invention provides a hammer that requires no electricity or other specialized equipment to operate. The subject invention also provides a hammer wherein the fastener objects are automatically advanced into the head of the hammer, so that the user is not required to handle individual fastener objects when using the hammer. The invention also provides a means by which fastener objects can be driven into another material or object more quickly, preferably with a single stroke from the hammer, in any position.

### BRIEF SUMMARY

The present invention pertains to a hammer wherein the head can have a spring-loaded sliding weight sufficient for driving fastener objects, such as nails, tacks, brads, or similar objects. Also provided is a torsion-spring mechanism utilized with a trigger mechanism that can automatically advance the fastener objects through the shaft of the hammer into the head of the hammer one at a time.

### BRIEF DESCRIPTION OF DRAWINGS

FIG. 1 shows a side elevation of the subject invention. FIG. 2 shows a side elevation wherein a portion of the head casing and shaft of the hammer are removed to show the interior features of an embodiment of the subject invention.

FIG. 3 shows a top plan view of the shaft of an embodiment of the subject invention wherein the outer casing has been removed to show the general placement of fastener objects therein and movement thereof by the torsion spring mechanism.

FIG. 4 is an enlarged view of the trigger mechanism utilized with the torsion-spring mechanism of the subject invention.

FIG. 5 is a cut-away view of a portion of the shaft illustrating the torsion-spring mechanism and the track therein along which the fastener objects are pulled via the spring mechanism. Also illustrated are the retaining clip channels that hold a trigger mechanism and retaining clip.

FIG. 6A is a cut-away view of a portion of the handle with an example of a fastener object positioned on the track within the shaft.

FIG. 6B shows the retaining clip that holds the trigger mechanism within the shaft of an embodiment of the subject invention.

FIG. 6C is a view of the retainer clip with the trigger mechanism installed therein.

FIG. 7 is a view of one embodiment of the trigger mechanism.

FIG. 8 is a cut-away view of a portion of the shaft illustrating the retaining clip and trigger mechanism positioned within the retaining clip channels.

FIG. 9 is a side view of the retaining clip with the trigger mechanism.

FIG. 10 illustrates one embodiment for connecting the cap to the head casing using one or more screws.

### DETAILED DISCLOSURE

The subject invention provides a hammer of similar construction as those known in the art that have an elongated shaft with a head affixed at one end. The subject invention further provides a head with a sliding weight for driving or pounding fastener objects, such as, for example, nails, tacks, brads, or similar objects. The subject invention further provides a means for automatically advancing the fastener objects through the handle towards the head of the hammer. Upon reaching the head of the hammer of the subject invention, the fastener objects are advanced singly into a chamber within the head of the hammer. In use, the sliding weight advances towards the fastener object with sufficient momentum to drive the fastener object through the chamber in the head of the hammer and into the material or object that has been struck.

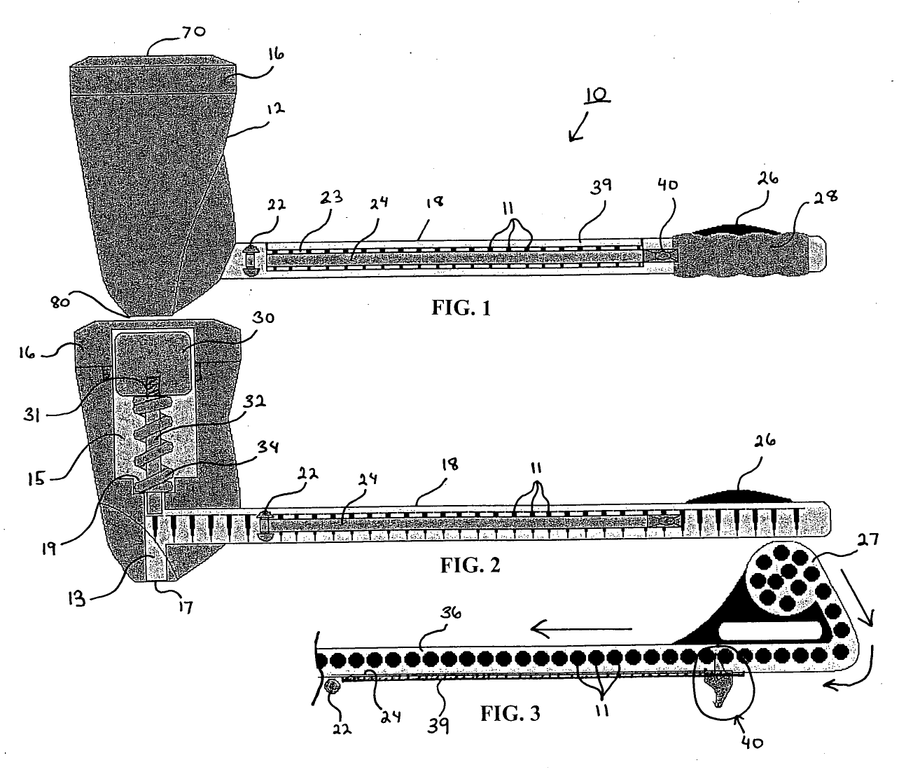

The head of the hammer is, essentially, a casing for holding or containing the movable parts utilized to drive or pound fastener objects 11, like nails, tacks, brads, etc. The head casing 12 can be made from a variety of materials, including, but not limited to, metals, plastics, wood, various elastomeric materials, rubber, or combinations thereof, etc. The head casing 12 can be solid, or can have various openings along the sides and/or the upper end 70 that allow access into a chamber 15. In a preferred embodiment, as shown in FIGS. 1 and 2, the head casing 12 is generally closed such that the chamber 15 is completely surrounded by the head casing 12. However, as will be discussed below, the head casing 12 is not directly utilized to drive fastener objects 11. Therefore, it can be beneficial for the head casing 12 to be manufactured using relatively sturdy, lightweight materials. However, it can be appreciated that the head casing 12 should be able to endure the impact forces that will be placed upon the hammer head when using the hammer. Therefore, careful consideration should be given to the one or more materials that can be used for the head casing 12. The sizes of the head casing 12 can be dependent upon the materials from which it is made, as well as the size of the interior working elements. In general, the head casing is approximately 3 inches to about 8 inches from the top end 70 to the bottom end 80. In a preferred embodiment, the head casing is approximately 4 inches to about 6 inches from the top end 70 to the bottom end 80.

The size and shape of the head casing can depend upon the size and shape of the interior moving parts. A person with skill in the art would recognize that the shape of the head casing can vary depending upon the ultimate use of the hammer. In an embodiment, the head casing is essentially tubular. In a preferred embodiment, the head casing is essentially tubular with a slight thickening near the shaft portion, as shown in FIGS. 1 and 2. In a further preferred embodiment, the circumference of the head casing 12 is approximately 2 inches to about 4 inches at the top end 70 and tapers to a circumference of approximately 0.5 inches to about 3 inches at the bottom end 80. In a preferred embodiment, the head casing is approximately 3 inches at the top end 70 and tapers to a circumference of approximately 1 inch at the bottom end 80.

The subject invention also utilizes a movable force delivery weight 30 of sufficient sturdiness and heaviness to drive or force fastener objects 11 into another material. The delivery weight 30 is preferably made of a dense metal or metal alloy, for example, lead, steel or combinations thereof could be utilized with the force delivery weight 30. In a preferred embodiment, the force delivery weight comprises steel-encased lead. The force delivery weight should provide sufficient force, in combination with the kinetic force of the user to insert or drive fastener objects into another material, for example, wood, sheet rock, roofing shingles, etc. Thus, the kinetic force and/or the swing radius of the user can compensate for longer or shorter fastener objects. Likewise, kinetic force and/or swing radius can be adjusted to compensate for materials with a denser or an otherwise more difficult to penetrate composition.

In a preferred embodiment, the force delivery weight 30 is positioned within a chamber 15 in the head of the hammer. An opening 17 at the bottom end 80 of the hammer head allows for the exit of fastener objects from the head of the hammer, as will be discussed below. In an embodiment, the chamber 15 contains the force delivery weight 30 and is shaped such that the force delivery weight can move essentially to the top end 70 and to the bottom end 80 of the hammer. When the hammer is struck against an object or material, the force delivery weight 30 moves towards the bottom end 80 of the hammer. In a further embodiment, the movable force delivery weight 30 further comprises a drive pin 32 attached at one end to the force delivery weight 30, preferably, closest to the bottom end 80 of the head casing 12. In still a further embodiment, the chamber 15 is contiguous with a drive pin chamber 13 located at the bottom end 80 of the head casing 12, wherein the drive pin chamber 13 is contiguous with the opening 17 at the bottom end 80 of the head casing 12. FIG. 2 illustrates an example of a head casing 12 with a force delivery weight 30 and a drive pin 32 positioned within a chamber 15.

In a preferred embodiment, the bottom end 80 of the head casing 12 is struck or pounded against an object which provides kinetic force to cause the force delivery weight 30 to be pushed towards the bottom end 80 of the hammer. The drive pin 32 attached at one end to the force delivery weight 30 is pushed by the force delivery weight into the drive pin chamber 13 such that the other end of the drive pin is pushed towards the opening 17 at the bottom end 80 of the head casing 12. FIG. 2 illustrates an embodiment of the drive pin 32 within the drive pin chamber 13. The drive pin 32 should be sturdy enough to withstand the forces upon it when the force delivery weight pushes against it to drive fastener objects. The drive pin can comprise, for example, but is not limited to, high impact resistant plastics, steel, titanium, or various types of alloys, etc.

The drive pin can be connected to the force delivery weight using various methods known in the art. For example, the drive pin 32 may be connected to the force delivery weight 30 via a bolt, screw, threaded rod, 31 or similar means. The drive pin 32 can alternatively be splined and pressed into the force delivery weight 30. In a further alternative embodiment, the drive pin 32 and force delivery weight 30 can be manufactured as a single piece of material, that can further be, for example, turned on a lathe to obtain the desired configuration.

In another embodiment, one or more recoil mechanisms or devices can be utilized to support and recoil the force delivery weight 30 to the top end 70 of the hammer after the hammer head casing 12 is struck or pounded against an object or material. The one or more recoil mechanisms can be, for example, not limited to, various elastic objects or devices, elastomeric materials, springs, rubber pieces, or similar materials. The one or more recoil mechanisms can also have a variety of circumferential shapes, including, but not limited to, squared, triangular, circular, oval, or other any other polygonal or polygonal-like shape. However, the rigidity and length of the recoil device should be sufficient to support and adequately recoil the force delivery weight 30, but also allow the force delivery weight to move relatively quickly to the bottom end 80 of the chamber 15 when the hammer head is struck against another object or material. In still another embodiment, the one or more recoil mechanisms are positioned around the drive pin 32, within the chamber 15, such that the one or more recoil mechanism are positioned, essentially between the drive pin 32 and the wall of the chamber 15. The adjustments of the recoil mechanism with regard to the force delivery weight 30 can be accomplished using techniques already known to those with skill in the art. The recoil of the force delivery weight 30 to the top end of the chamber 15 ensures that the hammer is ready for successive strikes or poundings. This allows the hammer 10 to be used at a relatively quicker rate than typical hammers known in the art.

In an embodiment, one or more springs 34 are utilized as a recoil mechanism to support the force delivery weight 30 and to recoil the force delivery weight to the top end 70 of the hammer head casing 12, as shown in FIG. 2. The one or more springs 34 can have a variety of circumferential shapes, including, but not limited to, squared, triangular, circular, oval, or any other polygonal or polygonal-like shape. In a preferred embodiment, a single spring 34 is utilized to support and recoil the force delivery weight 30. In still another preferred embodiment, the circumference of the spring 34 is essentially circular.

The efficiency of the hammer head mechanism depends upon the ability of the force delivery weight 30 to move or slide from the top end 70 to the bottom end 80 of the chamber 15 without unnecessary resistance. Therefore, it can be important for the force delivery weight 30 to be positioned within the chamber so as to minimize unnecessary resistance from the walls of the chamber, or, possibly, jamming of the force delivery weight within the chamber or of the drive pin 32 within the drive pin chamber 13. Therefore, in a preferred embodiment, the drive pin 32 is positioned through the center of the one or more recoil mechanisms. In a preferred embodiment, as illustrated in FIG. 2, the drive pin 32 is positioned within the center of a single spring 34, which acts as the recoil mechanism. In a further preferred embodiment, this single spring is positioned within the center of the chamber 15. The spring can be generally free to move along the length of the drive pin 32, and able to slide arbitrarily from the top end 70 to the bottom end 80 of the drive pin 32. In this embodiment, the spring would have sufficient coil resistance to prevent the drive pin 32 from engaging with a fastener object, unless the hammer head has been struck against an object or material with sufficient force, as will be discussed below. In a preferred embodiment, the length of the spring 34 is such that one end of the spring 34 is supported by the bottom end 80 of the chamber 15 and the opposite end of the spring supports the force delivery weight 30 (FIG. 2). In an embodiment, the coil spring 34 could be attached to the bottom end 80 of the chamber and/or to the force delivery weight 30. The spring can be attached in a variety of ways, including, for example, snaps, screws, clamps, threading, gluing, welding, sliding clips, etc.

In a further embodiment, the bottom end 80 of the chamber 15 can have one or more counter-sunk depressions 19 on the bottom end of the chamber 15. The one or more springs 34 would be positioned such that the end of the one or more springs nearest the bottom end of the chamber 15 are within the one or more depressions. These depressions 19 can have a variety of circumferential shapes, including, but not limited to, squared, triangular, circular, oval, or other polygonal shape capable of containing the ends of the one or more coil spring 34. In another embodiment, the one or more depressions can be of sufficient depth and diameter to maintain the end of the spring in a single position and prevent movement or sliding of the spring 34 around the drive pin 32. In this embodiment, the depressions do not prevent rotation of the spring around the drive pin 32. However, one with skill in the art would easily recognize that it would be possible to secure the spring at either end to prevent the spring from sliding and rotating around the drive pin 32.

In a preferred embodiment, a single depression 19 is centered around the top end of the drive pin chamber 13, as shown in FIG. 2. The end of the spring 34 nearest the bottom end 80 of the chamber 15 is placed within this single depression 19, as illustrated in FIG. 2. In this position, in a further preferred embodiment, the coils of the spring surround the opening to the drive pin chamber 13, and further, do not interfere with movement of the drive pin 32, that is centered in the spring, into or out of the drive pin chamber 13. The depression should be an appropriate depth and circumference to maintain the spring 34 in position around the drive pin chamber, such that compression of the spring does not inhibit the end of the drive pin 32 from reaching the opening at the bottom of the drive pin chamber 17.

In a preferred embodiment, the depression 19 is approximately 0.25 inch to about 0.5 inch in depth. In still a further preferred embodiment, the depression 19 is essentially circular with a circumference sufficient to contain an end of the spring 34.

In a still further embodiment, the hammer head casing 12 can have one or more openings that allow access to the interior chamber 15 and/or the drive pin chamber 13. The openings can be located along the sides or either end of the head casing, such that access to the force delivery weight 30, spring 34, drive pin 32, etc. is accomplished. With access to the working components of the hammer head, it would be possible to adjust the length of the drive pin 32, as mentioned above, or to make other adjustments to interior components if necessary. In yet another further embodiment, the opening can also have a covering that can be secured in place, by various means known in the art, when the hammer is in use.

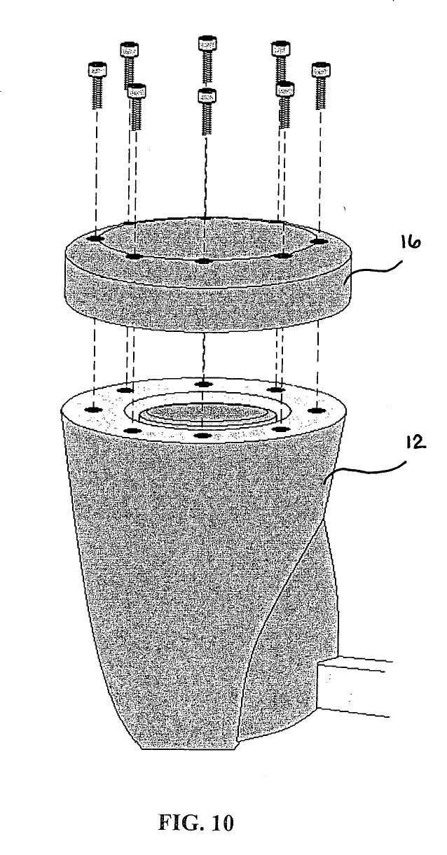

In a preferred embodiment, the subject invention utilizes a cap 16. In a further preferred embodiment, the cap 16 is located at the top end 70 of the head casing 12, as shown in FIG. 2. The cap 16 can be secured to the top end of the head casing 12 by a variety of one or more techniques or devices known in the art. In one embodiment, the cap 16 is screwably attached to the head casing. Thus, unscrewing and removing the cap 16 of this embodiment allows access to the chamber 15. Once the cap 16 is removed, the moving components in the head casing, i.e., force delivery weight 30, spring 34, and drive pin 32, can be removed as well. These components can then be adjusted or changed as necessary. In a preferred embodiment, the cap 16 is connected to the head casing via one or more screws, for example as shown in FIG. 10.

For convenience, a lanyard or other device can be used to attach the cap to the hammer and prevent it from being dropped or lost when the cap is disengaged from the head casing. One with skill in the art would realize that there are a number of techniques that could be used to secure the cap to the hammer when the cap is disengaged. Other methods include various magnets, specialized holders or containers, etc. used with the subject invention to reduce or eliminate the possibility of the cap being lost when disengaged from the head casing.

In the subject invention, the head casing 12 can be fixedly attached to a shaft 18 by which the hammer is typically held when striking or pounding the head casing 12 against another object or material. The shaft can be elongated and of variable length. In one embodiment, the shaft is approximately 8 to about 14 inches long. In a preferred embodiment, the shaft is approximately 11 to about 13 inches long. In a most preferred embodiment, the shaft is approximately 12 inches long.

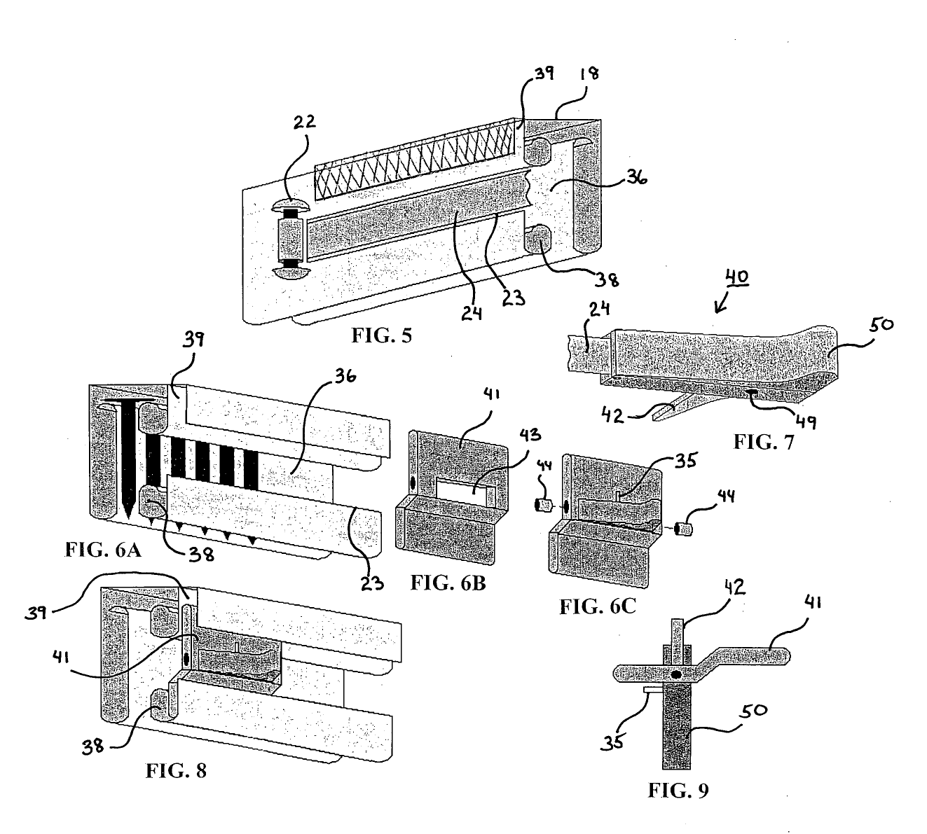

The shaft can comprise a variety of materials including, but not limited to, metals, plastics, woods, rubber, etc., or composites thereof. It may also be possible to manufacture the shaft from components or materials specially designed to absorb shock or jarring. A person with skill in this art would be familiar with materials and/or techniques best suited for manufacturing a shaft for the subject invention. In an embodiment, shown in FIGS. 5 and 6A, the shaft comprises folded sheet metal.

In a further embodiment, the shaft 18 of the subject invention can be fashioned with a channel 36 therein to allow the passage of fastener objects 11 along the shaft and into the drive pin chamber 13. In yet a further embodiment, the size and shape of the channel are such that the fastener objects are allowed into the channel in essentially single-file. In this embodiment, the side walls and/or top of the channel 36 can also provide support to the fastener objects to ensure that they pass in an essentially single-file fashion towards the drive pin chamber 13 in the head casing 12. In a preferred embodiment, the fastener objects 11 present to the drive pin chamber with the pointed end facing the bottom end 80 of the head casing, and the opposite end, or head end, facing the end of the drive pin 32 that is furthest from the force delivery weight 30, as shown in FIG. 2.

In a preferred embodiment, the channel 36 is formed as an essentially“T-shaped” channel, as shown in FIGS. 5 and 6A, along which fastener objects are carried or driven in single-file, as shown in FIGS. 2 and 6A. Fastener objects can be positioned or loaded into the “T-shaped” chamber so that the flattened heads of the fastener objects 11, if present, can rest upon the“shoulders” formed by the“T-shaped” channel 38, which allows the shanks of the fastener objects to swing or slide along the main portion of the channel, as shown in FIG. 6A. Fastener objects 11 without flattened heads can simply move along the channel 38 supported by the sides, top and an additional bottom of the channel. Thus, in a preferred embodiment, the channel is sufficiently wide enough to allow passage of the fastener objects 11 in single-file fashion, but narrow enough to prevent overlapping, bunching, or jamming of fastener objects 11 within said channel 38.

The channel can extend for any desired length of the shaft, and fastener objects can be introduced or loaded via an opening at any point along the channel. In one embodiment, the fastener objects are loaded at the end of the channel furthest from the head casing 12. This would allow the maximum number of fastener objects to be loaded into the channel, and can ensure that the nails remain in a single-file within the channel.

In another preferred embodiment, the“T-shaped” channel extends along almost the entire length of the shaft 18, as shown in FIG. 2. In still a further preferred embodiment, the channel extends into the head casing and terminates just prior to the drive pin chamber 13, such that the fastener objects can be presented singly into the drive pin chamber 13.

To facilitate movement of the fastener objects in a single-file process, the subject invention can utilize fastener objects 11 commonly referred to as“collated” nails, brads, etc. Collated fastener objects are positioned vertically side by side and connected in a variety of fashions, including paper strips, wire, welding, glue, etc. It is important that the connection between the fastener objects be strong enough to hold the objects together, but easy enough to break when the top or head-end of one of the fastener objects is struck. Such collated nails, brads, screws, tacks, etc. are well known in the art. In a preferred embodiment, the subject invention is designed to utilize almost any commonly available collated fastener objects 11.

The movement of the fastener objects 11 within the channel 38 can be facilitated by a variety of methods. In the simplest embodiment, the position of the hammer simply allows gravity to move the fastener objects towards the head casing 12, and into the drive pin chamber 13. In another embodiment, one or more spring-like devices are positioned within or around the channel 38, to push the fastener objects toward the drive pin chamber 13.

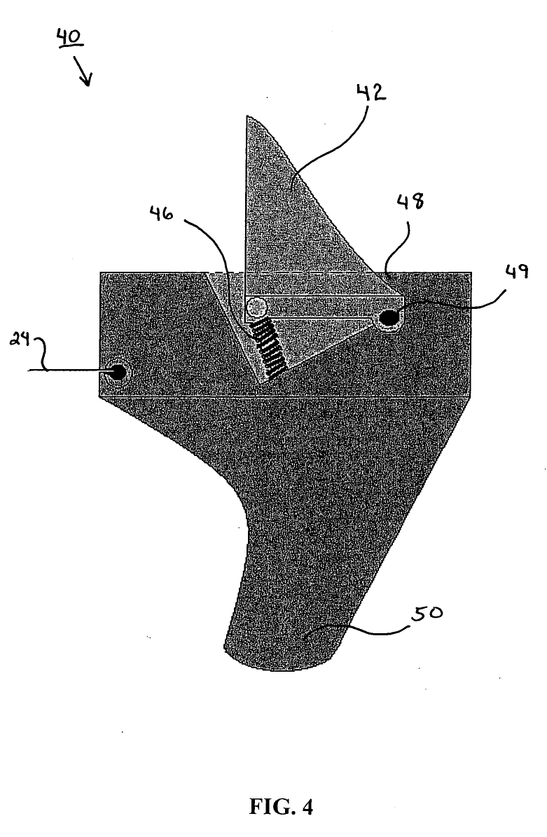

In a preferred embodiment, a forward-assisting torsion-spring mechanism 24 is utilized to pull the fastener objects 11 towards the drive pin chamber 13, as shown in FIGS. 1, 2, and 3. Typically, a torsion-spring mechanism comprises an elongated band 24, wire, or other string-like device, attached at one end to a torsion-coil 22 and at the other end to a trigger 40, as shown in FIGS. 1, 2 and 3. These mechanisms are commonly known in the art, as used for example in tape measures, retracting cords, etc. In a preferred embodiment, the torsion-coil 22 of the subject invention is fixedly attached at or near the head casing. The band 24 of the torsion-spring mechanism is wound around the torsion-coil, and when unwound is able to extend the required length of the shaft. A trigger mechanism is fixedly attached to the opposite end of the band 24. The trigger-mechanism, for example as illustrated in FIG. 4, comprises essentially a trigger tab 50 and a catch tooth 42. The trigger tab 50 can be fixedly attached to the retaining clip using a variety of techniques. Alternatively, the trigger tab 50 and retaining clip can comprise a single unit. In one embodiment, the trigger tab is held in position within the retaining clip with one or more trigger tab holders 44, for example as illustrated in FIG. 6C.

In order to utilize the trigger mechanism 40, the catch-tooth 42 should have some type of access to the fastener-objects, preferably the shank portion thereof. Thus, in a preferred embodiment, the shaft 18 has a trigger slot 23 along a portion of the length of the shaft through which the trigger mechanism travels to and from the torsion-coil 22. The catch-tooth 42 can be of sufficient length to be placed between at least two fastener objects 11 through this trigger slot 23, as shown in FIG. 3. However, it will be recognized that the trigger mechanism can have more than one catch tooth 42 for positioning between two or more fastener objects.

The trigger tab 50 on the trigger mechanism 40 is a means to pull, or unwind, the band 24 along the length of the shaft. The band 24, which is under tension from the torsion-coil 22 to which it is attached, causes the catch tooth 42, when positioned between two fastener objects, to put pressure on the fastener objects 11 positioned in front of the catch tooth, or those between the catch tooth and the drive pin chamber 13. This causes the fastener objects 11 to move towards the drive pin chamber 13 at a constant rate each time one of the fastener objects is driven out of the head casing 12 by the drive pin 32. If collated fastener objects are utilized in the device, the fastener objects 11 behind the catch tooth 42 are also pulled along with the fastener objects in front of the catch tooth. The band 24 becomes shorter each time a fastener object 11 is ejected or driven from the drive pin chamber 13. When the band 24 has shortened to the point where the trigger mechanism is at or near the torsion-coil 22, the trigger tab 50 can be used to pull the band and the trigger mechanism back down a length of the shaft so that the catch tooth 42 can be positioned again between two more fastener objects 11.

In a still further preferred embodiment, the catch tooth 42 is pivotally connected at 49 to the trigger mechanism 40 such that the catch tooth can be moved out of one position between fastener objects 11 when the trigger mechanism is pulled some distance towards the end of the shaft to another position between different, more distant, fastener objects.

In a further embodiment, one or more recoil mechanisms or devices can be utilized to ensure that the catch tooth 42 is held in proper position to be placed or wedged between fastener objects 11 once the trigger mechanism has been positioned in the trigger slot 23. In a preferred embodiment, a spring 46 between the trigger mechanism and the catch tooth 42, as shown in FIG. 4, holds the catch tooth in position, but allows the catch tooth 42 to be pushed back and into the trigger mechanism 40 as it is pulled across the shanks of the fastener objects 11 in order to re-set the torsion-spring mechanism. When the trigger mechanism is pulled through the trigger slot 23 and the catch tooth 42 is at the position to wedge it between two fastener objects, the spring 46 pushes the catch tooth between the fastener objects and activates the pulling force from the torsion-coil 22 to move the fastener objects towards the drive pin chamber 13. In a further embodiment, as shown in FIG. 4, the trigger mechanism 40 can be further equipped with means to limit movement of the catch tooth 42 such that the catch tooth can only be moved in one direction. Otherwise, it is not be possible to apply pressure to the fastener objects once the catch tooth 42 was in position. In a preferred embodiment, a wedge 48 on the trigger mechanism 40 limits the movement of the catch tooth.

In another embodiment, the catch tooth has a release mechanism that when required allows the trigger and retaining clip to be moved in either direction, along the length of the trigger slot. In a preferred embodiment, there is a spring retainer 35 attached to the trigger mechanism. The spring retainer 35 allows the catch tooth 42 to be manually pulled into and held within the trigger tab 50. This allows the retaining clip and trigger tab to be moved along the length of the retaining clip channels 38 without engaging with fastener objects within the shaft. This can allow, for example, the removal of fastener objects from the hammer. The forward-assisting resistance-spring mechanism of the subject invention is most efficient if used with collated fastener objects 11, such as those described above. However, it does not have to be used exclusively with collated fastener objects. As iterated above, the channel 36 can be designed with sufficient width and height to allow fastener objects, collated or otherwise, to pass along the channel in a single file. Standard, non-collated, fastener objects in the channel can push against each other as the trigger mechanism 40 and the catch tooth 42 applied pressure to the row of fastener objects in the channel 36.

In a further preferred embodiment, the trigger mechanism 40 is positioned within a retaining clip 41, for example as illustrated in FIG. 6B. The retaining clip 41 can assist in maintaining the trigger mechanism 40 at or near the shaft 18, which in turn can help maintain the catch tooth 42 between the fastener objects 11. In one embodiment, the retaining clip 41 is positioned within the channel 36 against the fastener objects. The trigger tab 50 positioned within the trigger slot 23 can be used to pull the retaining clip 41 through the channel 36 against the fastener objects 11 at the same time the band 24 is being unwound from the torsion-coil 22. The trigger mechanism 40 is designed to fit within an opening 43 in the retaining clip 41, shown in FIG. 6B, and can be held in place with tabs, screws, or other means.

In a preferred embodiment, the shaft has two parallel retaining clip channels 38 and 39, in addition to the fastener object-channel 15. In a further preferred embodiment, the upper retaining clip channel 39 is slightly offset from the lower retaining clip channel, for example as illustrated in FIG. 6A. In a further preferred embodiment, the retaining clip channels 38 and 39, in which the bottom and top of the retaining clip 41 can be positioned, respectively, to move back and forth with the trigger mechanism 40, is parallel to the fastener object channel 15. In a still further preferred embodiment, the retaining clip is bent or curved horizontally, as illustrated in FIG. 6B, 6C and 8, to accommodate positioning within the dual retaining clip channels 38 and 39. An example of the dual retaining clip channels 38 and 39 of the preferred embodiment is shown in FIGS. 5, 6A and 6E.

In a further preferred embodiment, a handle 28 is provided at or near the end of the shaft furthest from the head casing 12. The handle 28 is used to grasp the hammer to avoid contact with the trigger mechanism and the one or more channels in the shaft 18. It also allows for the maximum kinetic force when the hammer 10 is swung and struck against an object or material. A person with skill in the art will recognize that there can be any number of materials used to make or cover said handle 28 to maximize comfort, shock absorption, aesthetic aspects, etc.

The subject invention can also comprise a storage chamber 27 for holding a supply of fastener objects. In one embodiment, said storage chamber can further be integrally connected to the fastener object channel 36 in the shaft 18 of the hammer. In a still further embodiment, the storage chamber can maintain fastener objects a proper position for continuous feeding or loading into the fastener object channel 36. In yet a further embodiment, the fastener objects 11 are stored in a coiled configuration within the storage chamber 27, for example as shown in FIG. 3. However, it can be appreciated by one with skill in the art that the storage chamber 27 could be designed to hold fastener objects 11 in a variety of configurations.

In a preferred embodiment, a storage chamber 27 is positioned at the end of the shaft 18, near the handle. An embodiment illustrated in FIG. 3 shows how the handle 28 and storage chamber 27 could be configured at the end of the shaft. The storage chamber 27 of the preferred embodiment is continuous with the channel 36 in the shaft 18. In a further preferred embodiment, the fastener objects are held within the storage chamber 27 in a position that allows them to be continuously fed into the chamber 15. A cap or cover 26 on the storage chamber allows access to the chamber for loading or positioning fastener objects 11. As mentioned above, the subject invention is most efficiently utilized with collated fastener objects 11. The storage chamber 27 of the preferred embodiment is also most efficient when utilized with collated fastener objects. However, it should be understood that the storage chamber 27 does not have to be used exclusively with collated fastener objects. When using collated fastener objects, the chamber may be essentially an area into which coiled reams of collated fastener objects can be placed. Such collated fastener objects 11 will not require much additional support within the chamber once the cap or cover 26 was placed on the storage chamber 27. In the event that individual fastener objects are utilized with the subject invention, a support mechanism could be fashioned by one with skill in the art to hold any number of individual, non-collated fastener objects once the cap or cover 26 was in place. It is important for the subject invention that the fastener objects within the storage chamber 27 be held in a position that allows them to be loaded into the channel 36 in the shaft 18 without jamming or fouling the hammer when in use.

In the preferred embodiment, the hammer of the subject invention is utilized by grasping the hammer 10 by the handle 28 and swinging the hammer 10 so that the bottom end 80 of the essentially hollow head casing 12 is struck against an object or material. The kinetic force caused by this movement and the subsequent striking of the head casing 12 causes the force delivery weight 30 within a chamber 15 in the head casing 12 to be forced towards the bottom end of the head casing 12. At the same time, the drive pin 32, positioned on the bottom end 80 of the force delivery weight 30, is rapidly accelerated into the drive pin chamber 13 by said force delivery weight 30. As the drive pin 32 is accelerated it contacts the top or head end of a fastener object which has been positioned within the drive pin chamber by a forward-assisting torsion-spring mechanism 24. The drive pin 32 accelerates through the drive pin chamber 13 pushing a single fastener object 11 out of the opening 17 at the bottom end 80 of the head casing 12. A spring 34 surrounding the drive pin 32 acts as a recoil mechanism to immediately extract the drive pin 32 from the drive pin chamber 13 and re-position the force delivery weight to the top end of the chamber 15 within the head casing.

Once the drive pin 32 has been completely extracted from the drive pin chamber 13, the forward-assisting torsion-spring mechanism 24 is able to push another fastener object into position within the drive pin chamber 13. Thus, with the force delivery weight 30 returned to position at the top end 70 of the chamber 15 and a fastener object 11 in position within the drive pin chamber 13, the hammer is immediately ready by the next swing.

As the forward-assisting torsion-spring mechanism 24 continues to push fastener objects 11 into the drive pin chamber, the band 24 of the torsion-spring mechanism becomes shorter and shorter until it becomes almost completely rewound around the torsion-spring. At that point, the trigger tab 50 secured within the retaining clip 41 is pushed or pulled through the trigger slot 23 so that the catch tooth 42 can be positioned behind another group of fastener objects 11 that it will pull towards the head casing 12 and, one at a time, into the drive pin chamber 13.

In a further preferred embodiment, collated fastener objects are utilized in order to provide a continuous line of fastener objects. Collated fastener objects 11 are correctly positioned to move in an uninterrupted line along the chamber 36 in the shaft 18 of the hammer without jamming or falling out of position.

It should be understood that the examples and embodiments described herein are for illustrative purposes only and that various modifications or changes in light thereof will be suggested to persons skilled in the art and are to be included within the spirit and purview of this application.

1. A hammer comprising:
a shaft with at least one channel for holding and feeding of fastener objects;
a head casing connected to said shaft having a chamber therein in communication with the at least one channel in the shaft;
a movable force delivery weight disposed within said chamber;
a drive pin connected to said force delivery weight;
a drive pin chamber contiguous with the channel in the head casing, and wherein the drive pin can be inserted,
such that in operation a fastener object in the channel is delivered to the drive pin chamber from where it is forced out by the action of the drive pin being forceably inserted into the drive pin chamber by the force delivery weight.

2. A hammer according to claim 1, wherein said head casing further comprises a removable cap.

3. A hammer, according to claim 2, wherein said cap is attached to said head casing with one or more screws.

4. A hammer, according to claim 1, wherein the height of said head casing is approximately 4 inches to about 8 inches and the circumference of said head casing is approximately 2 inches to about 4 inches at the capped end and approximately 0.5 inches to about 3 inches at the opposite, open end.

5. A hammer, according to claim 1, wherein the height of said head casing is approximately 3 inches to about 6 inches and the circumference of said head casing is approximately 2.5 inches to about 3.5 inches at the capped end and approximately 1 inch to about 2 inches at the opposite, open end.

6. A hammer, according to claim 1, wherein the head casing comprises an elastomeric material.

7. A hammer, according to claim 1, wherein the head casing comprises a metallic material.

8. A hammer, according to claim 1, wherein the head casing comprises a plastic material.

9. A hammer, according to claim 1, wherein the force delivery weight is supported by one or more recoil mechanisms positioned within the chamber.

10. A hammer, according to claim 9, wherein said recoil mechanism is a spring having a central channel therein through which the drive pin is movably positioned.

11. A hammer, according to claim 10, wherein the spring is positioned within a counter-sunk depression within the chamber, wherein the counter-sunk depression surrounds the top end opening to the drive pin chamber.

12. A hammer, according to claim 11, wherein the counter-sunk depression is approximately 0.25 inch to about 0.5 inch in depth around the top end opening to the drive pin chamber.

13. A hammer, according to claim 1, wherein the drive pin is adjustably connected to the force delivery weight.

14. A hammer, according to claim 13, wherein said drive pin is screwably connected to the force delivery weight.

15. A hammer, according to claim 1, wherein the at least one channel within the shaft accommodates collated fastener objects.

16. A hammer, according to claim 15, further comprising a fastener object storage chamber, such that the chamber is in communication with the fastener object channel in the shaft.

17. A hammer, according to claim 15, wherein said shaft is approximately 8 inches to about 14 inches in length.

18. A hammer, according to claim 15, wherein said shaft is approximately 12 inches in length.

19. A hammer comprising:
a shaft with at least one channel for holding and feeding of fastener objects;
a head casing connected to said shaft having a chamber therein in communication with the at least one channel in the shaft;
a movable force delivery weight disposed within said chamber;
a drive pin connected to said force delivery weight;
a drive pin chamber contiguous with the channel in the head casing, and wherein the drive pin can be inserted;
a torsion coil fixedly attached to the shaft of the hammer;
an elongated band-like device connected at one end to the torsion coil;
a trigger mechanism fixedly connected to the end of the band-like device opposite the torsion coil;
a retaining clip, wherein the trigger mechanism is fixedly attached;
at least one retaining clip channel positioned on or within the shaft of the hammer and parallel to the channel that holds and feeds fastener objects, wherein the retaining clip is slidably disposed;
a catch tooth rotatably connected to the trigger mechanism;
a trigger slot, parallel to the at least one retaining clip channel, into which the catch tooth on the trigger mechanism can extend in order to contact fastener objects positioned within the channel that holds and feeds fastener objects,
such that in operation, the catch tooth on the trigger mechanism, when positioned at the end of a row of fastener objects within the fastener object channel, is pulled by the action of the band attached to the trigger mechanism towards the torsion coil which causes the fastener objects to advance within the shaft towards the drive pin chamber, such that fastener objects in the channel are delivered to the drive pin chamber, where they are forced out of the drive pin chamber by the action of the drive pin being forceably inserted into the drive pin chamber by the force delivery weight.

20. A hammer according to claim 19, wherein the rotatable catch tooth is spring-loaded.

21. A hammer, according to claim 21, further comprising a release mechanism connected to the spring-loaded catch tooth, whereby the spring-loaded catch tooth can be depressed to allow the trigger mechanism within the retaining clip to be moved back and forth within the trigger slot.

22. A method for driving or pounding fastener objects into another material using a hammer comprising:
a shaft with at least one channel for holding and feeding of fastener objects;
a head casing connected to said shaft having a chamber therein in communication with the at least one channel in the shaft;
a movable force delivery weight disposed within said chamber;
a drive pin connected to said force delivery weight;
a drive pin chamber contiguous with the channel in the head casing, and wherein the drive pin can be inserted,
such that in operation, a fastener object in the channel is delivered to the drive pin chamber and where it is forced out of the drive pin chamber by the action of the drive pin being forceably inserted into the drive pin chamber by the force delivery weight

23. A method for driving or pounding fastener objects into another material using a hammer comprising:
a shaft with at least one channel for holding and feeding of fastener objects;
a head casing connected to said shaft having a chamber therein in communication with the at least one channel in the shaft;
a movable force delivery weight disposed within said chamber;
a drive pin connected to said force delivery weight;
a drive pin chamber contiguous with the channel in the head casing, and wherein the drive pin can be inserted;
a torsion coil fixedly attached to the shaft of the hammer;
an elongated band-like device connected at one end to the torsion coil;
a trigger mechanism fixedly connected to the end of the band-like device opposite the torsion coil;
a retaining clip, wherein the trigger mechanism is fixedly attached;
one or more retaining clip channels positioned on or within the shaft of the hammer and parallel to the channel that holds and feeds fastener objects, wherein the retaining clip is slidably disposed;
a catch tooth rotatably connected to the trigger mechanism;
a trigger slot, parallel to the one or more retaining clip channels, into which the catch tooth on the trigger mechanism can extend in order to contact fastener objects positioned within the channel that holds and feeds fastener objects,
such that in operation, the catch tooth on the trigger mechanism, when positioned at the end of a row of fastener objects within the fastener object channel, is pulled by the action of the band attached to the trigger mechanism towards the torsion coil which causes the fastener objects to advance within the shaft towards the drive pin chamber, such that fastener objects in the channel are delivered to the drive pin chamber, where they are forced out of the drive pin chamber by the action of the drive pin being forceably inserted into the drive pin chamber by the force delivery weight.

24. A kit comprising:
a) a hammer, wherein said hammer comprises
a shaft with at least one channel for holding and feeding of fastener objects;
a head casing connected to said shaft having a chamber therein in communication with the at least one channel in the shaft;
a movable force delivery weight disposed within said chamber;
a drive pin connected to said force delivery weight;
a drive pin chamber contiguous with the channel in the head casing, and wherein the drive pin can be inserted,
a torsion coil fixedly attached to the shaft of the hammer;
an elongated band-like device connected at one end to the torsion coil;
a trigger mechanism fixedly connected to the end of the band-like device opposite the torsion coil;
a retaining clip, wherein the trigger mechanism is fixedly attached;
one or more retaining clip channels positioned on or within the shaft of the hammer and parallel to the channel that holds and feeds fastener objects, wherein the retaining clip is slidably disposed;
a catch tooth rotatably connected to the trigger mechanism;
a trigger slot, parallel to the one or more retaining clip channels, into which the catch tooth on the trigger mechanism can extend in order to contact fastener objects positioned within the channel that holds and feeds fastener objects;
b) a fastener object storage chamber; and
c) collated fastener objects.
